(19) United States
(12) Patent Application Publication
(10) Pub. No.: US 2024/0335933 A1
(43) Pub. Date: Oct. 10, 2024

(54) MULTIPLE POSITION NON-CONTACT TRIGGER SYSTEM FOR A POWER TOOL

(71) Applicant: INGERSOLL-RAND INDUSTRIAL U.S., INC., Davidson, NC (US)

(72) Inventors: Daniel J. Becker, Monroe Township, NJ (US); Joshua O. Johnson, Allentown, PA (US)

(21) Appl. No.: 18/615,476

(22) Filed: Mar. 25, 2024

Related U.S. Application Data
(60) Provisional application No. 63/494,818, filed on Apr. 7, 2023.

(51) Int. Cl. B25F 5/00; B25B 21/02

(52) U.S. Cl. CPC B25F 5/001; B25B 21/02

(57) ABSTRACT

An impact tool having a multiple position non-contact trigger system. The trigger system includes a trigger member having at least one magnet moveable along a plurality of non-contact sensors when the trigger member moves from a non-actuated position to a fully actuated position. The plurality of non-contact sensors sense the movement of the trigger member and output a corresponding signal to a controller. The controller may command the impact tool to perform a function from a plurality of functions based on the position of the trigger element, where each position of the trigger element may correspond to a different mode of the power tool system.

### BACKGROUND

Impact tools are power tools configured to deliver a high torque output by storing energy in a rotating mass and delivering it suddenly through an output shaft to a fastener. As impact tools are used in applications that require high cycle counts, trigger systems are prone to failure.

### DRAWINGS

The Detailed Description is described with reference to the accompanying figures. The use of the same reference numbers in different instances in the description and the figures may indicate similar or identical items.

FIG. 1 is a cross-sectional perspective view of an impact tool having an impact assembly and a multiple-position non-contact trigger system in accordance with example embodiments of the present disclosure.

FIG. 2 is a partial cross-sectional side view of a multiple-position non-contact trigger system, such as the one shown in FIG. 1, at a non-actuated position in accordance with example embodiments of the present disclosure.

FIG. 3 is a partial cross-sectional side view of the multiple-position non-contact trigger system of FIG. 2 at a partially actuated position in accordance with example embodiments of the present disclosure.

FIG. 4 is a partial cross-sectional side view of the multiple-position non-contact trigger system of FIG. 2 at a fully actuated position in accordance with example embodiments of the present disclosure.

FIG. 5A is a graph illustrating speed versus trigger position/time of the multiple-position non-contact trigger system shown in FIG. 1, showing uniform acceleration ramps between trigger positions in accordance with example embodiments of the present disclosure.

FIG. 5B is a graph illustrating speed versus trigger position/time of the multiple-position non-contact trigger system shown in FIG. 1, showing nonlinear acceleration ramps between trigger positions in accordance with example embodiments of the present disclosure.

FIG. 5C is a graph illustrating speed versus trigger position/time of the multiple-position non-contact trigger system shown in FIG. 1, showing nonlinear acceleration ramps between trigger positions in accordance with example embodiments of the present disclosure.

FIG. 6 is a block diagram illustrating a controller for a power tool, such as the power tool illustrated in FIG. 1, in accordance with example embodiments of the present disclosure.

### DETAILED DESCRIPTION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

### Overview

Impact tools (e.g., impact wrenches, etc.) are designed to deliver a high torque output with minimal exertion by the user. A rotating mass (e.g., a hammer) stores energy and abruptly delivers the stored energy to an anvil connected to an output shaft, subjecting the anvil to repeated and sudden shock loading.

Typical cordless impact tools have contact-type triggers and are used in industries that may require a low usage of the impact tool (e.g., 50 cycles per day). Contact-type triggers use electromechanical trigger switches that include elements prone to wearing. These contact-type triggers are subject to erosion from electrical arcing and/or repeated back-and-forth motion. Cordless impact tools are being used more frequently in assembly-line applications (e.g., manufacturing) as users prefer them over direct-drive tools that create a reaction or kick-back into the users' hands. As impact tools are used in assembly applications, the duty cycle of the impact tool increases significantly (e.g., 2000 to 4000 cycles per day) along with the number of contact-type switch failures. In these applications, the frequency of preventive maintenance interventions to change a contact-type trigger systems increases, causing unavailability of tools, production delays, etc.

Accordingly, the present disclosure is directed to a power tool, for example an impact tool, having a multiple position non-contact trigger system. The trigger system includes a trigger member having at least one magnet moveable along a plurality of non-contact sensors when the trigger member is partially or fully actuated. The plurality of non-contact sensors sense the movement of the trigger member and output a corresponding signal to a controller. The controller may command the impact tool to perform a function from a plurality of functions based on the position of the trigger element, where each position of the trigger element may correspond to a different mode of the power tool system. The multiple position non-contact trigger system increases the durability of the power tool, especially in applications that require a high number of cycles per day.

### Detailed Description of Example Embodiments

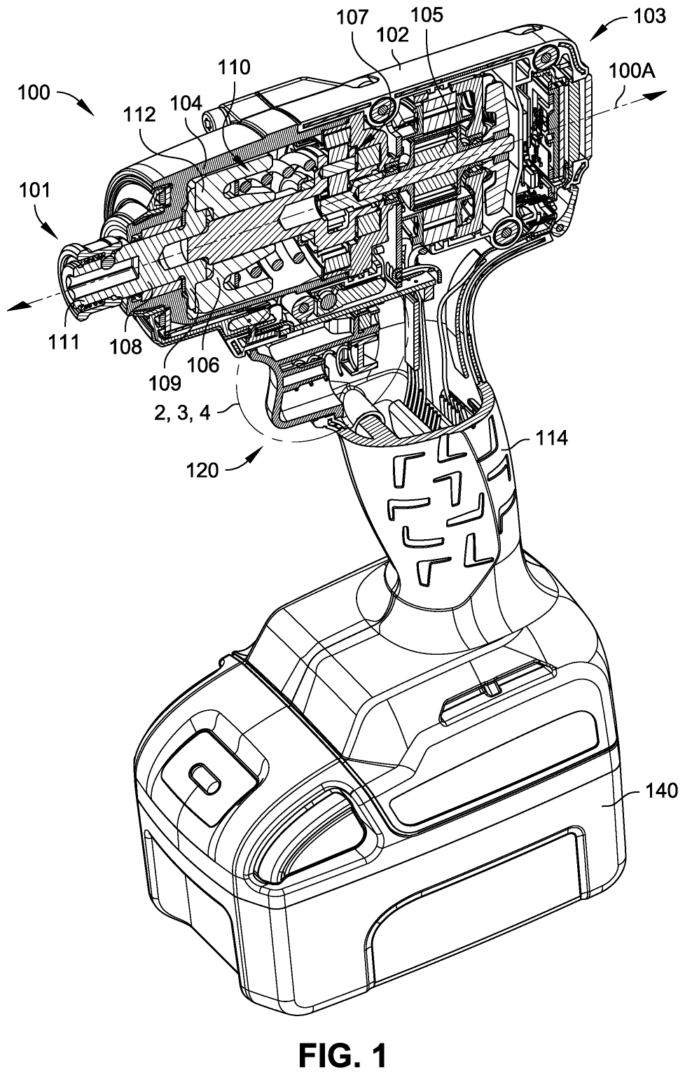

Referring generally to FIGS. 1 through 4, a power tool assembly 100 having a multiple position non-contact trigger system 120 is described. FIG. 1 shows an illustrative embodiment of a power tool assembly 100 in accordance with the present disclosure. The impact tool includes a housing 102 having a front end 101 and a rear end 103. The power tool assembly 100 includes a hammercase 104 that houses an impact assembly 110. The housing 102 includes a drive mechanism 105 that rotates a hammer 106 of the impact assembly 110 around an output axis 100A. The output axis 100A extends from the front end 101 to the rear end 103. The housing may include a gear set assembly 107 connecting the drive assembly 105 with the hammer 106. The housing 102 shown employs a pistol grip design wherein a handle 114 comprises a pistol type grip that is generally perpendicular to the output axis 100A. In other embodiments, the handle 114 may be parallel to (e.g., coaxial with) the output axis 100A. In embodiments, the drive assembly 105 may be generally perpendicular to the output axis 100A. In other embodiments, the drive assembly 105 may be parallel to (e.g., coaxial with) the output axis 100A.

In the embodiment illustrated, the power tool assembly 100 comprises an impact wrench. However, those of skill in the art will understand that the power tool assembly 100 is not limited to an impact wrench and that a variety of different elements may be used. For example, other power tools suitable for use by the power tool assembly 100 can include fastening tools used for fastening and unfastening threaded fasteners such as, but not limited to, impact drivers, nut runner tools, pulse wrenches, grinders, drills, combination hammers, screwdrivers, clutch tools, and so forth. In embodiments, the power tool assembly 100 may include right-angle tools such as nut runners or right angle impact tools. In embodiments, the drive mechanism 105 comprises an electric motor powered by a power source such as a removable battery 140, an internal battery, or an external power source via an electric cord (not shown). However, it is contemplated that the rotary power tool assembly 100 may also comprise a pneumatic tool having a drive mechanism 105 employing a pneumatic (compressed air) motor powered by a source of compressed air.

The hammer 106 includes at least one hammer jaw 112. The impact assembly 110 further includes an anvil 108 disposed inside the hammercase 104. The anvil 108 includes at least one anvil jaw 109 configured to be repeatedly struck by the at least one hammer jaw 112. The hammer 106 continuously and intermittently impacts the anvil 108, causing it to continually rotate. An output shaft 111 extends from the anvil 108 and may receive a connector or other device that engages a fastener (e.g., a bolt, a nut, a screw, etc.) to be tightened or loosened.

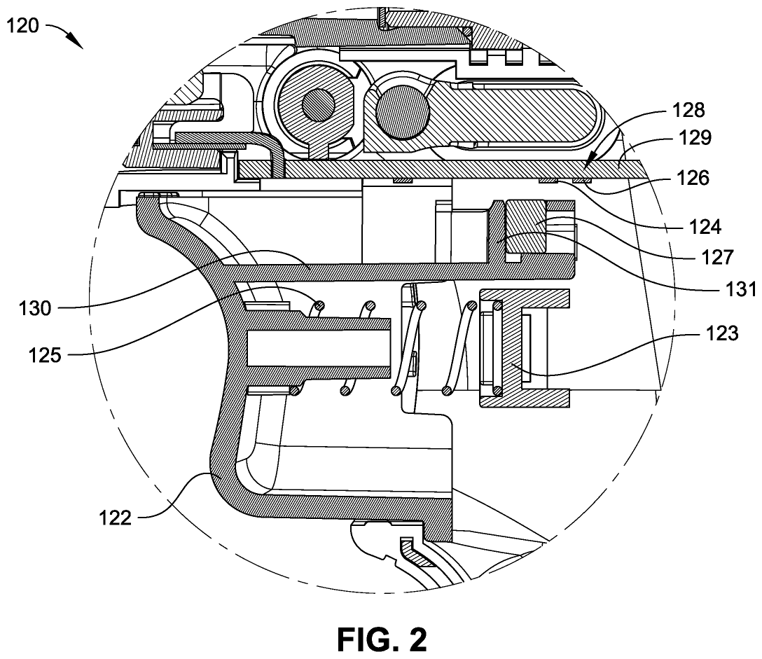

As shown in FIGS. 2 through 4, the impact tool 102 includes a multiple-position non-contact trigger system 120. The multiple-position non-contact trigger system includes a trigger member 122 and a biasing member 125 disposed proximate to the handle 114 in the housing. The trigger member 122 is configured to be partially or fully actuated by a user. The multiple-position non-contact trigger system 120 controls the actuation of the drive mechanism 105. The multiple-position non-contact trigger system 120 includes a sensor assembly 128 having a circuit board 129 mounted on or in the housing 102. The circuit board 129 includes a plurality of non-contact sensors, for example a first sensor 124 and a second sensor 126 connected therewith. In another embodiment, the multiple position non-contact trigger system 120 may only include a first sensor 124 connected to the circuit board 129. In yet another embodiment, the multiple position non-contact trigger system 120 includes more than two non-contact sensors disposed in the housing 102.

The multiple position non-contact trigger system 120 may include a magnet 127 mounted on the trigger member 122. As the trigger member 122 is pushed against the handle 114 and partially actuated or fully actuated, the magnet 127 moves relative to the first sensor 124 and the second sensor 126. In example embodiments (not shown), the non-contact sensors may be disposed on the trigger member 122 while the magnet 127 may be disposed in or on the housing 102. In other embodiments, the multiple position non-contact trigger system 120 may include a plurality of magnets. The plurality of magnets may be identical to each other or vary in size, shape, and/or magnetic strength.

In example embodiments, the magnet 127 is supported by a magnet support surface 130 extending from an inner surface of the trigger member 122. The magnet support surface 130 may include one or more retaining walls 131 configured to retain the magnet 127 from horizontal displacement. In the embodiment shown, at least one side of the magnet 127 is open to the circuit board 129. In other embodiments, the magnet 127 may be housed within a closed cavity of the magnet support surface 130.

In an example embodiment, the non-contact sensors, namely the first sensor 124 and the second sensor 126 are Hall Effect sensors. Hall effect sensors may be selected from a group including Hall switches, linear Hall sensors, direct angle sensors, or any combination thereof. Hall switches are Hall effect sensors that measure and compare the strength of the magnetic field of a magnet up to a predetermined or fixed threshold level in the sensor. As the value of the threshold level is exceeded, an output transistor of the Hall switch may be switched on or off, depending on the desired application. Hall switches may include simple switches, double plate switches, and programmable switches. Linear Hall sensors provide proportional outputs based on the magnetic field strength of the magnet. Compared to Hall switches, linear Hall sensors do not have a discrete switching state and provide a signal that is linearly proportional to the strength of the magnetic field. Direct angle Hall sensors compare sine and cosine measurements of the magnetic field instead of measuring the absolute magnetic field. It should be understood that the plurality of non-contact sensors may all be selected as one type of Hall effect sensor or as a combination of the different types of Hall effect sensors previously discussed. In other embodiments, the non-contact sensors may be magnetorestrictive sensors or other sensors that receive and analyze a signal from a magnetic field.

In the embodiments illustrated, the trigger member 122 is biased towards the direction of the front end 101 of the power tool assembly 100 by the biasing member 125. In embodiments, the biasing member 125 may be a helical compression spring. It is contemplated that other biasing mechanisms may be used to bias the trigger member 122 in the direction of the front end 101 of the power tool 100. As a user pushes the trigger member 122 towards the direction of the rear end 103 of the power tool 100, the biasing member 125 may be compressed against a support member 123. The biasing member 125 may be at least one of a helical spring, a coil spring, a torsion spring, a lead spring, among others. In other embodiments, the biasing mechanism 125 may be a non-contact biasing mechanism. For example, an inner surface of the trigger member 122 and the support member 123 may include magnets configured to repel each other, thereby biasing the trigger member 122 to the non-actuated position shown in FIG. 2. The magnets may include permanent magnets or electromagnets. In other embodiments, the biasing member 125 may include air cylinders.

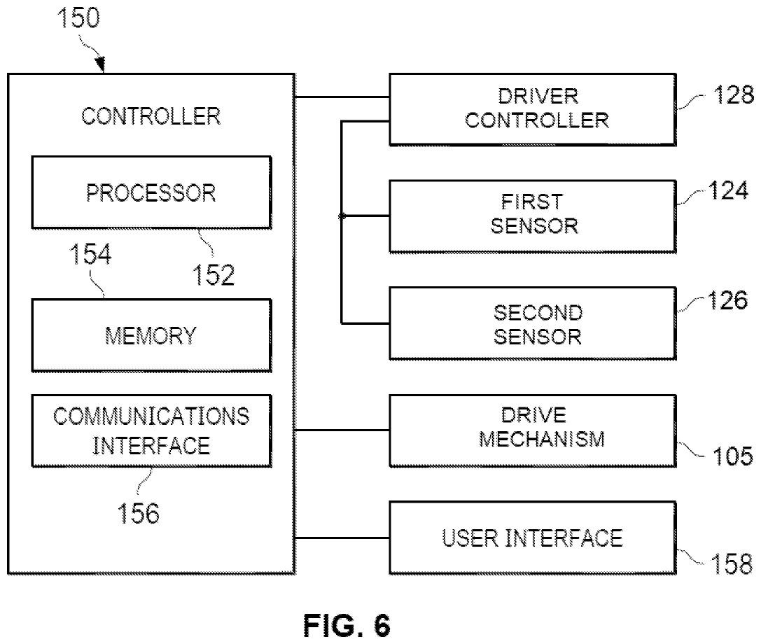

The power tool assembly 100 includes a control system 150, as shown in FIG. 6, described below, where the control system 150 is in communication with a driver controller, for example, the circuit board 129 of the sensor assembly 128. The control system 150 receives an output signal emitted by the first sensor 124 and the second sensor 126 corresponding to the position of the magnet 127 with respect to the first sensor 124 and the second sensor 126, respectively. Based on the output signal received by the plurality of non-contact sensors, the control system 150 may control the actuation of the drive mechanism 105. For example, controller 150 may select a first fastening profile of the impact tool 100 when the magnet 127 activates the first sensor 124 and change the fastening profile of the impact tool 100 to a second fastening profile when the magnet 127 activates the second sensor 126. In other embodiments, the controller may select a different fastening profile if the magnet 127 is within a sensing range of both the first sensor 124 and the second sensor 126.

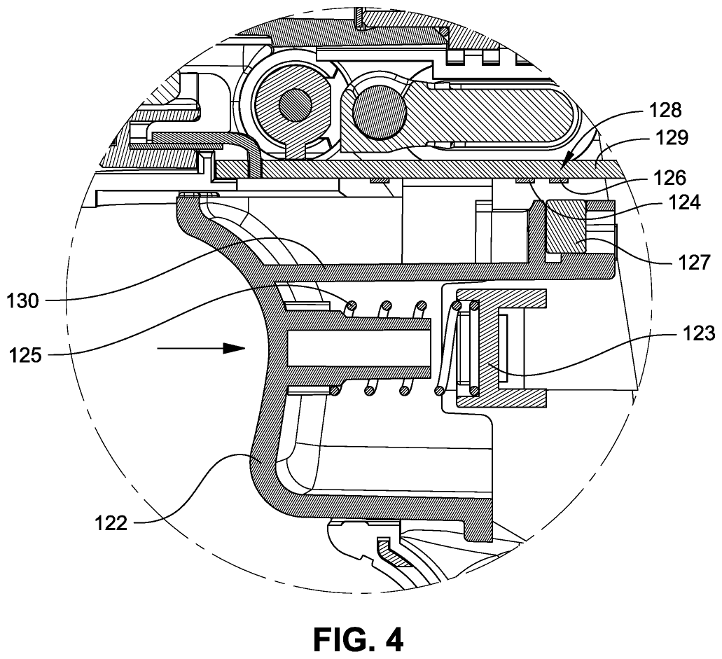

The multiple position non-contact trigger system 100 may include multiple trigger points, or predetermined positions along the travel distance of the trigger element 122 as it is moved from the non-actuated position (FIG. 2) to the fully actuated position (FIG. 4). The non-contact sensors (the first sensor 124 and the second sensor 126) sense the movement of the trigger element 122 and commands the power tool assembly 100 to perform one of a plurality of functions depending on the trigger point reached or the position of the magnet with respect to the first sensor 124 and the second sensor 126. Each of the trigger points may correspond to a different mode of the power tool system 100.

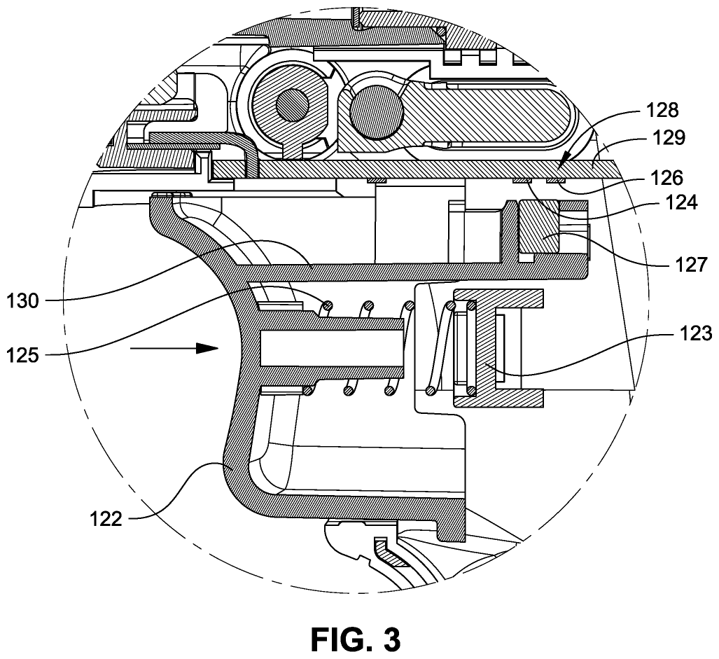

For example, the plurality of functions may include turning the impact tool on at a first predetermined speed when the magnet is at a partially actuated position as shown in FIG. 3. As the trigger element 122 further reaches the fully actuated position, shown in FIG. 4, the control system 150 commands the power tool assembly 100 to perform another one of the plurality of functions, such as but not limited to changing the speed of the power tool assembly 100 to a second predetermined speed different from the first predetermined speed. Thereby, in embodiments, the multiple position non-contact trigger system 120 provides speed control to the power tool assembly 100. The first predetermined speed may be a discrete speed that remains constant regardless of a change in the travel distance of the trigger element 122 until the next trigger point, for example the fully actuated position, is reached. Once the fully actuated position is reached, the drive mechanism 105 may be commanded to rotate at the discrete second predetermined speed and so forth.

In embodiments, acceleration ramps are applied to each one of the multiple positions of the trigger element 122 to control a fastening profile of the power tool assembly 100, for example, a velocity profile. For example, a first trigger point reached may activate a first speed, for example a slow-speed mode, where the first speed may be slower than the second predetermined speed to have a better control of the fastening and reduce the chance of damaging the fastener (e.g., by angular cross threading). A second trigger point reached may correspond to a high-speed mode where the second predetermined speed is higher than the first predetermined speed and may be used to complete the fastening of the fastener when the fastener is in a desired angular alignment. The trigger points may be reached at predetermined travel distances of the trigger element 122. In other embodiments, the trigger points may be reached after the trigger element 122 has remained within a predetermined travel between the different positions for a predetermined amount of time. In other words, a trigger point may correspond to a point of travel of the trigger element, or a point in time after the trigger element has traveled between two different positions.

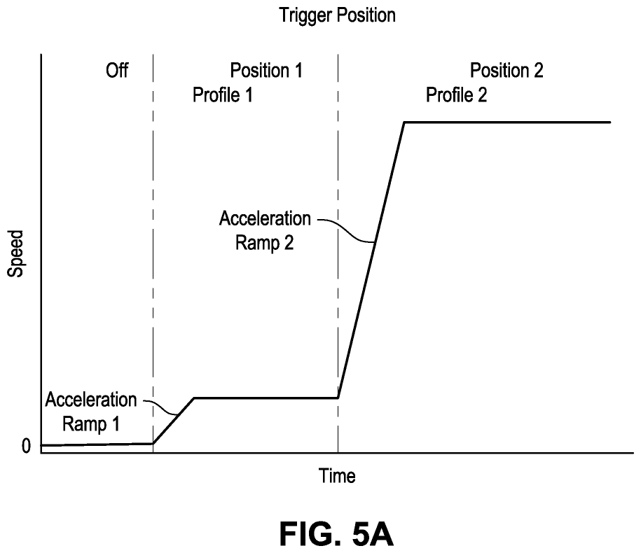

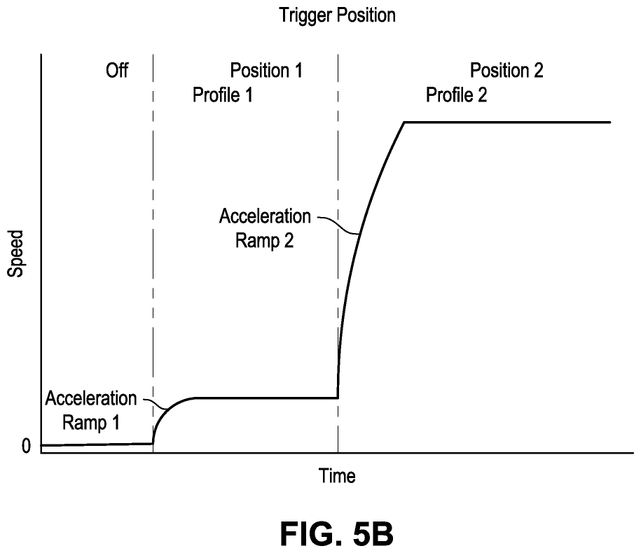

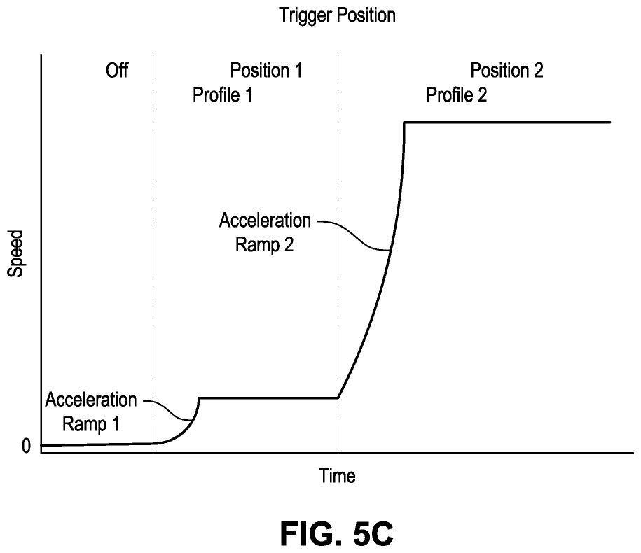

In example embodiments, acceleration ramps as shown in FIGS. 5A through 5C could be applied to each one of the multiple positions of the trigger element 122 to ramp up or increase the speed of the drive mechanism 105 over a period of time, e.g., as the trigger element 122 moves from a partially actuated position to a fully actuated position. It should be understood that although the partially actuated position has been discussed as one trigger point, multiple partially actuated positions may each be used as a different trigger point. For example, the multiple-position non-contact trigger system 120 may include two or more trigger points, between the non-actuated position of FIG. 2 and the fully actuated position of FIG. 4, where each of the trigger points corresponds to a change in a designated function.

FIGS. 5A through 5C show examples of the speed of the drive mechanism 105 based on a position of the trigger element 122. As the trigger element 122 changes positions from the non-actuated position/off position (FIG. 2) to the partially actuated position (FIG. 3), the magnet 127 enters the range of the first sensor 124, activating the sensor 124. The sensor 124 may send a signal indicating to the controller 150 that a first trigger point has been reached. As the first trigger point is reached, the controller 150 may actuate the power tool assembly 100 to accelerate (acceleration ramp 1) from rest to the first predetermined speed. As the trigger element 122 changes positions from the partially actuated position (FIG. 3) to the fully actuated position (FIG. 4), the magnet 127 enters the range of the second sensor 126, activating the sensor 126. The sensor 126 may send a signal indicating to the controller 150 that a second trigger point has been reached. As the second trigger point is reached, the controller 150 may actuate the power tool assembly 100 to accelerate (acceleration ramp 2) from the first predetermined speed to the second predetermined speed.

The acceleration ramps or acceleration rates at which the controller 150 accelerates the drive mechanism 105 in between predetermined speeds may be uniform or linear acceleration rates as shown in FIG. 5A. The rate of acceleration may also be a non-linear rate. In other embodiments, the acceleration rates may decrease between a first and second trigger point until reaching the respective predetermined first and second speeds as shown in FIG. 5B. In yet another embodiment, the acceleration rates may increase between a first and second trigger point until reaching the respective predetermined first and second speeds as shown in FIG. 5C. In other embodiments (not shown), one of the acceleration rates may increase between a first or a second trigger points, while the other acceleration rate may decrease between the other first or second trigger points, and vice versa.

For example, each one of the multiple partially actuated positions may correspond to a running speed of the drive mechanism 105, allowing the power tool assembly 100 to continuously accelerate as the trigger element 122 is moved from the non-actuated position to the fully actuated position. The number of trigger points may correspond to the number of non-contact sensors disposed in the power tool assembly 100. For example, the first sensor 124 may be a Hall switch sensor that activates the drive mechanism 105 and the second sensor 126 may be a linear Hall sensor that is powered only after the drive mechanism 105 has been activated.

In embodiments where the power tool assembly includes only one (1) non-contact sensor, predetermined output values of the one non-contact sensor may each correspond to a trigger point, still allowing the control system to command the drive mechanism to rotate at discrete speeds.

The multiple position non-contact trigger system 120 may be configured to command different tasks or perform in different modes through the actuation of the same trigger element 122. In embodiments, the multiple position non-contact trigger system 120 includes a plurality of modes (e.g., fastening profiles) that control a different function of the power tool assembly 100 other than the direct speed of the drive mechanism 105. For example, a different mode controlled by the multiple position non-contact trigger system 120 may include a mode in which a predetermined number of cycles is run by the drive mechanism 105 at a lower speed, after which the control system commands the drive mechanism 105 to increase its speed without a user changing the position of the trigger element 122. In a different mode controlled by the multiple position non-contact trigger system 120 may be programmed to decrease the speed of the drive mechanism 105 after running at a first predetermined speed for a predetermined number of cycles ran by the drive mechanism 105 without a user changing the position of the trigger element 122.

In another embodiment, a mode of the multiple position non-contact trigger system 120 may be a mode in which the drive mechanism 105 runs for a first predetermined time period when a trigger point is reached, for example in the partially actuated position of the trigger element 122. If the trigger element 122 is moved towards a different position reaching another trigger point, the control system may command the drive mechanism to run for a second predetermined time period different than the first predetermined time period. In yet another embodiment, a mode of the multiple position non-contact trigger system 120 may be a mode in which the drive mechanism 105 runs in a backwards or reverse direction when a trigger point is reached and runs in a forward direction to fasten the fastener once another trigger point is reached. It should be understood that the order of the modes actuated when the different trigger points are reached by the trigger element 122 as it travels from the non-actuated position to the fully actuated position may be different from the ones described herein.

In embodiments, the multiple position non-contact trigger system 120 may activate an accessory connected to the power tool system 100 when the trigger element 122 is moved to a partially actuated position and passes by the first trigger point. The drive mechanism 105 may be actuated only after the trigger element is moved to a different position (e.g., a fully actuated position) and passes by a second or different trigger point. Examples of the accessories that may be connected to the power tool system 100 include but are not limited to barcode readers, cameras, lighting features, sensors, etc.

In embodiments, the power tool assembly 100 may include a user interface 158 having a mode selector connected to the housing 102 where the mode selector changes the function of the multiple position non-contact trigger system 120 as the trigger element 122 reaches the first trigger point. For example, in one mode of the mode selector, the first trigger point may be configured to activate a first accessory and in a second mode of the mode selector, the first trigger point may be configured to activate a second accessory. It should be understood that any of the features or fastening profiles discussed herein may be included as a different mode of the mode selector.

Referring now to FIG. 6, the power tool assembly 100, including some or all of its components, can operate under computer control. For example, a processor 152 can be included with or in the housing 102 to control the components and functions of the power tool assembly 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the power tool assembly 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The power tool assembly 100 can be coupled with the controller 150 for controlling the power tool assembly 100. The controller 150 can include the processor 152, a memory 154, and a communications interface 156. The controller 150 may be in communication with the driver controller 128 to control the actuation of the drive mechanism 105. Moreover, the controller 150 may receive information from the plurality of non-contact sensors, for example the first sensor 124 and the second sensor 126 to adjust the speed or mode of the drive mechanism 105 as desired based on the position of the trigger 122.

The processor 152 provides processing functionality for the controller 150 and can include any number of processors, micro-controllers, or other processing systems, and resident or external memory for storing data and other information accessed or generated by the controller 150. The processor 152 can execute one or more software programs that implement techniques described herein. The processor 152 is not limited by the materials from which it is formed or the processing mechanisms employed therein and, as such, can be implemented via semiconductor(s) and/or transistors (e.g., using electronic integrated circuit (IC) components), and so forth.

The controller 150 includes the memory 152. The memory 152 is an example of tangible, computer-readable storage medium that provides storage functionality to store various data associated with operation of the controller 150, such as software programs and/or code segments, or other data to instruct the processor 152, and possibly other components of the controller 150, to perform the functionality described herein. Thus, the memory 154 can store data, such as a program of instructions for operating the power tool assembly 100 (including its components), and so forth. It should be noted that while a single memory 154 is described, a wide variety of types and combinations of memory (e.g., tangible, non-transitory memory) can be employed. The memory 154 can be integral with the processor 152, can comprise stand-alone memory, or can be a combination of both.

The memory 154 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the controller 150 and/or the memory 154 can include removable integrated circuit card (ICC) memory, such as memory provided by a subscriber identity module (SIM) card, a universal subscriber identity module (USIM) card, a universal integrated circuit card (UICC), and so on.

The controller 150 includes the communications interface 156. The communications interface 156 is operatively configured to communicate with components of the controller 150. For example, the communications interface 156 can be configured to transmit data for storage in the controller 150, retrieve data from storage in the controller 150, and so forth. The communications interface 156 is also communicatively coupled with the processor 152 to facilitate data transfer between components of the controller 150 and the processor 152 (e.g., for communicating inputs to the processor 152 received from a device communicatively coupled with the controller 150). It should be noted that while the communications interface 156 is described as a component of a controller 150, one or more components of the communications interface 156 can be implemented as external components communicatively coupled to the controller 150 via a wired and/or wireless connection. The controller 150 can also comprise and/or connect to one or more user interfaces 158 or input/output (I/O) devices (e.g., via the communications interface 156), including, but not necessarily limited to: a display, a mouse, a touchpad, a keyboard, and so on. As described, the user interface 158 can be used to display information including, but not necessarily limited to: the mode of the power tool 100, the speed of the power tool 100, and other information that is useful to an operator of the power tool assembly 100 during operation, setup, and so on.

The communications interface 156 and/or the processor 152 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a Wi-Fi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); an extranet; an intranet; and so on. However, this list is provided by way of example only and is not meant to limit the present disclosure. Further, the communications interface 156 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

While the subject matter has been illustrated and described in detail in the drawings and foregoing description, the same is to be considered as illustrative and not restrictive in character, it being understood that only example embodiments have been shown and described and that all changes and modifications that come within the spirit of the subject matters are desired to be protected. In reading the claims, it is intended that when words such as “a,” “an,” “at least one,” or “one of a plurality of” are used there is no intention to limit the claim to only one item unless specifically stated to the contrary in the claim. Unless specified or limited otherwise, the terms “mounted” and “connected” and variations thereof are used broadly and encompass both direct and indirect mountings, connections, and couplings. Further, “connected” is not restricted to physical or mechanical connections or couplings.

What is claimed is:

1. A power tool comprising:
a housing configured to house a drive mechanism; and
a multiple position trigger system including:
a trigger member having at least one magnet, the trigger member configured to be actuated between a plurality of positions,
a sensor assembly disposed in the housing proximate to the trigger member, the sensor assembly including a plurality of non-contact sensors,
wherein when the trigger member is actuated between a non-actuated position and a fully actuated position, the at least one magnet sequentially activates respective ones of the plurality of non-contact sensors, and where activation of respective ones of the plurality of non-contact sensors each cause activation of a corresponding fastening profile of the power tool.

2. The power tool of claim 1, wherein the plurality of non-contact sensors comprises to a first sensor and a second sensor.

3. The power tool of claim 2, wherein when the trigger member is actuated from the non-actuated position to a partially actuated position, the at least one magnet activates the first sensor, and when the trigger member is actuated from the partially actuated position to the fully actuated position, the at least one magnet activates the second sensor.

4. The power tool of claim 3, further comprising a controller in communication with the sensor assembly of the multiple position trigger system, the controller configured to select a first fastening profile of the impact tool when the at least one magnet activates the first sensor.

5. The power tool of claim 4, wherein the controller is configured to change the fastening profile of the impact tool to a second fastening profile when the at least one magnet activates the second sensor.

6. The power tool of claim 5, wherein the first fastening profile corresponds to a first speed of the drive mechanism, the second fastening profile corresponds to a second speed of the drive mechanism, and the second speed is higher than the first speed of the drive mechanism.

7. The power tool of claim 6, wherein the controller is configured to accelerate the drive mechanism from rest to the first speed as the trigger member is actuated from the non-actuated position to the partially actuated position and the first sensor is activated by the first magnet.

8. The power tool of claim 6, wherein the controller is configured to accelerate the drive mechanism from the first speed to the second speed as the trigger member is actuated from the partially actuated position to the fully actuated position.

9. The power tool of claim 2, wherein the first sensor is a switch Hall effect sensor, and the second sensor is a linear Hall effect sensor.

10. A multiple position trigger system for a power tool having a drive mechanism, the multiple position trigger system comprising:
a trigger member having at least one magnet, the trigger member configured to be actuated between a plurality of positions,
a plurality of non-contact sensors disposed in the housing proximate to the trigger member,
wherein when the trigger member is actuated between a non-actuated position and a fully actuated position, the at least one magnet activates different ones of the plurality of non-contact sensors, and where activation of different ones of the plurality of non-contact sensors each correspond to activation of a different fastening profile of the power tool.

11. The multiple position trigger system of claim 10, wherein the plurality of non-contact sensors corresponds to a first sensor and a second sensor.

12. The multiple position trigger system of claim 11, wherein when the trigger member is actuated from the non-actuated position to a partially actuated position, the at least one magnet activates the first sensor, and when the trigger member is actuated from the partially actuated position to the fully actuated position, the at least one magnet activates the second sensor.

13. The multiple position trigger system of claim 12, further comprising a controller in communication with the plurality of non-contact sensors of the multiple position trigger system, the controller configured to select a first fastening profile of the power tool when the at least one magnet activates the first sensor.

14. The multiple position trigger system of claim 13, wherein the controller is configured to change the fastening profile of the power tool to a second fastening profile when the at least one magnet activates the second sensor.

15. The multiple position trigger system of claim 14, wherein the first fastening profile corresponds to a first speed of the drive mechanism, the second fastening profile corresponds to a second speed of the drive mechanism and the second speed is higher than the first speed of the drive mechanism.

16. The multiple position trigger system of claim 13, wherein the controller is configured to accelerate the drive mechanism from rest to the first speed as the trigger member is actuated from the non-actuated position to the partially actuated position and the first sensor is activated by the at least one magnet.

17. The multiple position trigger system of claim 16, wherein the controller is configured to uniformly accelerate the drive mechanism from the first speed to the second speed as the trigger member is actuated from the partially actuated position to the fully actuated position and the second sensor is activated by the at least one magnet.

18. The multiple position trigger system of claim 10, wherein the first sensor is a switch Hall sensor, and the second sensor is a linear Hall sensor.

19. An impact tool comprising:
a housing having a front end and a rear end and defining an axis extending between the front end and the rear end and a pistol grip, the housing configured to house a drive mechanism;
a hammer having at least one hammer jaw, the hammer configured to be driven by the drive mechanism about the axis;
an anvil disposed inside the housing, the anvil defining at least one anvil configured to periodically engage with the at least one hammer jaw to rotate the anvil about the axis; and
a two-position trigger assembly disposed in the pistol grip, the two-position trigger assembly including:
a trigger member having at least one magnet, the trigger member configured to be actuated between a non-actuated position, a partially actuated position, and a fully actuated position,
a sensor assembly disposed in the housing proximate to the trigger member, the sensor assembly including a first non-contact sensor and a second non-contact sensor, wherein when the trigger member is actuated from the non-actuated position to the partially actuated position, the at least one magnet activates the first sensor, and when the trigger member is actuated from the partially actuated position to the fully actuated position, the at least one magnet activates the second sensor; and
a controller in communication with the sensor assembly, the controller configured to select a first fastening profile of the impact tool when the at least one magnet activates the first sensor and to change the fastening profile of the impact tool to a second fastening profile when the at least one magnet activates the second sensor.

20. The impact tool of claim 19, wherein the first fastening profile corresponds to a first speed of the drive mechanism and the second fastening profile corresponds to a second speed of the drive mechanism.
